(19) United States
(12) Patent Application Publication
(10) Pub. No.: US 2026/0323346 A1
(43) Pub. Date: Oct. 15, 2026

(54) Reporting of QoE reports to the SN

(71) Applicant: Telefonaktiebolaget LM Ericsson (publ), Stockholm (SE)

(72) Inventors: Cecilia Eklöf, Täby (SE); Johan Rune, Lidingö (SE); Luca Lunardi, Genova (IT); Filip Barac, Huddinge (SE); Mattias Bergström, Sollentuna (SE)

(21) Appl. No.: 19/120,102

(22) PCT Filed: Oct. 13, 2023
(86) PCT No.: PCT/IB2023/060364

§ 371 Date: Apr. 10, 2025

Related U.S. Application Data
(60) Provisional application No. 63/415,853, filed on Oct. 13, 2022.

(51) Int. Cl. H04W 24/10; H04W 24/08

(52) U.S. Cl. CPC H04W 24/10; H04W 24/08

(57) ABSTRACT

Methods and apparatuses for reporting quality-of-experience (QoE) in a network employing multi-connectivity. An example method, in a user equipment (UE), comprises receiving, from a radio network node, a configuration message comprising a QoE measurement configuration relating to at least one cell of a secondary node (SN) serving the UE. The method further comprises performing one or more QoE measurements, according to the QoE measurement configuration, and sending a report of the one or more QoE measurements to a cell of a master node (MN) serving the UE, where the sending comprises including the report in a message indicating that the included report is to be transferred to the SN.

### TECHNICAL FIELD

The present disclosure relates to wireless communications and, in particular, to techniques for reporting quality-of-experience (QoE) measurements in multi-node connectivity environments.

### BACKGROUND

### Overview of the QoE Framework and “Regular QoE”

Quality of Experience (QoE) measurements, also referred to as “application layer measurements,” have been specified for LTE and UMTS and for NR in 3GPP release 17. The purpose of the application layer measurements is to measure the end user experience when using certain applications. QoE measurements for streaming services and for MTSI (Mobility Telephony Service for IMS) services are supported in LTE and UMTS and for NR also VR is supported.

The solutions for regular QoE are similar in NR, LTE and UMTS with the overall principles as follows. Quality of Experience Measurement Collection (QMC) enables configuration of application layer measurements in the UE and transmission of QoE measurement result files (commonly referred to as QoE reports) to the network by means of RRC signalling. An application layer measurement configuration (also called QoE measurement configuration or QoE configuration) that the RAN receives from the OAM system or the CN is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

The configuration data related to QoE measurements (which in standard specifications are typically referred to as application layer measurements) is received by the gNB from OAM and consists of a service type indication, an indication of an area in which the measurements are to be performed (denoted area scope), an IP address of the entity the collected measurement results (i.e., the QoE reports) should be sent to (often referred to as a MCE, spelled out as Measurement Collector Entity or Measurement Collection Entity, but the entity may sometimes also be referred to as a Trace Collection Entity), and a set of instructions indicating a type of measurements that should be performed and details of how these measurements are to be performed. These instructions are intended for the application layer in the UE and are placed in a “container” that the network entities handling it, e.g., forwarding it to the UE, as well as the UE Access Stratum, cannot interpret and do not try to read.

The container is forwarded to the UE in RRC signaling, together with the indicated service type. For measurements in RRC_CONNECTED, the area is kept in the gNB and the network ensures that the UE measures in the correct area by configuring the UE when to start and stop the measurements. The area scope is defined in terms of cells or network related areas. In UMTS, an area scope is defined as either a list of cells, a list of routing areas or a list of tracking areas. In LTE and NR, an area scope is defined as either a list of cells or a list of tracking areas.

QoE, and in particular QoE configuration, comes in two flavors: management-based QoE configuration and signaling-based QoE configuration. In both cases the QoE configuration originates in the OAM system or some other administrative entity, e.g., dealing with customer satisfaction. All of these entities are in this document referred to as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (while also fulfilling any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the HSS (in EPS/LTE) or UDM (in 5GS/NR), which forwards the QoE configuration to the UE's current core network node (CN), e.g., an MME in EPS/LTE or an AMF in 5G/NR. The CN then forwards the s-based QoE configuration to the RAN node that serves the concerned UE and the RAN forwards it to the UE.

In both cases, forwarded to the UE are the service type indication and the container with the measurement instructions. The UE is not aware of whether a received QoE configuration is m-based or s-based. In legacy systems, the QoE framework is integrated with the pre-existing Trace functionality and a Trace ID is associated with each QoE configuration. In NR, the QoE functionality is logically separated from the Trace functionality, but still partly reuses the Trace signaling mechanisms. In both NR and LTE, a globally unique QoE reference (formed of MCC+MNC+QMC ID, where the QMC ID is a string of 24 bits) will be associated with each QoE configuration. The QoE reference is included in the container with measurement instructions and also sent to the RAN (i.e., the gNB in NR). For the communication between the gNB and the UE, the QoE reference is replaced by a shorter identifier denoted as measConfigAppLayerId, which is locally unique within a UE, i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container,” which is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing and the UE Access Stratum is also not automatically aware of this. To alleviate this, session start/stop indications have been introduced. These are sent from the application layer in the UE to the UE AS and from the UE AS to the RAN. A session end indication is sent when the application session and the associated QoE measurement session are concluded.

The RAN may decide to release a QoE configuration in a UE at any time, as an implementation-based decision. Typically, it is done when the UE has moved outside an area configured for the QoE measurements (commonly referred to as the area scope) and the measurement session has ended.

### RAN Visible QoE (RVQoE)

An extension of the QoE framework which has been implemented in 3GPP release 17 is the concept of RAN-visible QoE (RVQoE). Regular QoE reports, as described above, are intended for the MCE, which is an entity outside the RAN, e.g., a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as changing various parameters related to the scheduling of the UE and the data flows related to the application session.

### End-to-End Description of QoE Measurements

The end-to-end signalling for configuration of QoE measurements is described in 3GPP TS 28.405 v. 18.0.0, chapter 4. The activation of management based QoE in NR is shown in FIG. 1, which is taken from that specification. The activation of signalling based QoE in NR is shown in FIG. 2, which is taken from chapter 4.6 of the same specification.

### Configuration and Reporting of QoE and RVQoE Measurements in RRC

The configuration of QoE and RVQoE measurements is done by the RRC message RRCReconfiguration and the reports are sent in the RRC message MeasurementReportAppLayer according to the signaling flow shown in FIG. 3.

The RRCReconfiguration contains the information element AppLayerMeasConfig, which contains either a configuration container for configuration of regular QoE or RRC parameters for configuration of RVQoE. This information element (IE) is defined as below:

In existing specifications, the network can only configure RVQoE if there also is a corresponding configuration of regular QoE in the UE.

### QoE Metrics for Streaming Service

Specifications concerning QoE metrics for Progressive Download and 3GP-DASH services can be found in 3GPP TS 26.247, clause 10.

The following metrics shall be supported by progressive download clients supporting the QoE reporting feature:
Average Throughput,
Initial Playout Delay
Buffer Level
Play List
Device information.

The following metrics shall be supported by 3GP-DASH clients supporting the QoE reporting feature:
List of Representation Switch Events,
Average Throughput,
Initial Playout Delay,
Buffer Level,
Play List,
MPD Information,
Device information.

### AT-Commands

AT commands are used for communication between the AS (radio) layer and the application layer in the UE. The AT commands are defined in 3GPP TS 27.007 version 17.6.0. The AT commands are used in QoE for transferring of the configuration from the RRC layer to the application and for transferring of reports from the application layer to the RRC layer.

### 3GPP Dual Connectivity

In 3GPP Rel-12, the LTE feature Dual Connectivity (DC) was introduced, to enable the UE to be connected in two cell groups, each controlled by an LTE access node, eNBs, labelled as the Master eNB, MeNB and the Secondary eNB, SeNB. The UE still only has one RRC connection with the network. In 3GPP, the Dual Connectivity (DC) solution has since then been evolved and is now also specified for NR as well as between LTE and NR. Multi-connectivity (MC) is the case when there are more than 2 nodes involved. With introduction of 5G, the term MR-DC (Multi-Radio Dual Connectivity, see also 3GPP TS 37.340) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one PCell and one or more SCell(s). And within the Secondary Cell Group, SCG, controlled by the secondary node (SN), the UE may use one Primary SCell (PSCell, also known as the primary SCG cell in NR) and one or more SCell(s). This combined case is illustrated in FIG. 4. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA) and evolved packet core (EPC). In principle, NR and LTE can be deployed without any interworking, denoted by NR stand-alone (SA) operation, also known as Option 2, that is gNB in NR can be connected to 5G core network (5GC) and eNB in LTE can be connected to EPC with no interconnection between the two, also known as Option 1.

On the other hand, the first supported version of NR uses dual connectivity, denoted as EN-DC (E-UTRAN-NR Dual Connectivity), also known as Option 3, as depicted in FIG. 5. In such a deployment, dual connectivity between NR and LTE is applied, where the UE is connected with both the LTE radio interface (LTE Uu in the figure) to an LTE access node and the NR radio Interface (NR Uu in the figure) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a control plane connection to the core network (EPC) which instead is provided MeNB and in this case the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes).

It is worth noting that, there are also other variants of dual connectivity between LTE and NR which have been standardized as part of NG-RAN connected to 5GC. Under the MR-DC umbrella are:
EN-DC (Option 3): LTE is the master node and NR is the secondary node (EPC CN employed, as depicted in FIG. 5)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master node, MN, controlling the MCG, and the secondary node, SN, controlling the SCG, are NR (5GCN employed, as depicted in FIG. 6).

### SUMMARY

A problem with existing technology is that if the UE is configured to perform QoE measurements from a secondary node (SN), there is currently no possibility for the UE to transmit an SN-related QoE report to the SN. Different solutions have been discussed to transmit the reports directly to the SN by using SRB3 or a new SRB5, but SRB3/5 may not always be implemented or configured. Normally, the MN instructs the SN to set up a direct SRB towards the UE.

The techniques and apparatuses described herein address this problem by providing a method for a UE to transmit QoE reports intended for a Secondary Node (SN), indirectly in a transfer message via a Master Node (MN) and then via an XnAP message from the MN to the SN. The transfer message from the UE may be sent on SRB4.

Also disclosed herein are methods for an MN or an SN to determine whether to configure the UE with QoE/RVQoE measurements intended to be sent to the SN and updates to network procedure to enable the configuration. The configuration of the QoE measurements may also be included in a transfer message via the MN to the UE.

A method to retrieve QoE measurements from the UE is also included, as are network aspects of the retrieval. The solution is applicable for signalling-based and management-based QoE measurements and a dedicated method for the case of management-based QoE measurements is included.

The disclosed techniques, apparatuses, and systems provide the possibility to transmit SN related QoE reports to the SN, indirectly, in a transfer message via the MN, where the transfer message may be first sent from the UE to the MN on SRB4 and then via XnAP from the MN to the SN.

The disclosed solutions enable the UE to transmit a QoE report intended for the SN to the SN, even if no direct communication towards the SN has been configured, e.g., in terms of SRB3 or correspondingly. With this solution, the QoE report can be sent without having to attach any explicit information to the MN, such as e.g., an indication that the report is intended for the SN. The report can also be sent at any time, i.e., even if the UE at the time has no information to send to the MN. That makes the solution flexible and clear in how the reports are sent and to which node the reports are intended and allows the reports to be sent to the network directly when received by the AS layer in the UE.

### BRIEF DESCRIPTION OF THE FIGURES

FIG. 1 illustrates the activation of management-based QoE in NR.

FIG. 2 illustrates the activation of signaling-based QoE in NR.

FIG. 3 is a signaling flow diagram showing the configuration of QoE and RVQoE measurements.

FIG. 4 is a block diagram illustrating dual connectivity combined with carrier aggregation in MR-DC.

FIG. 5 illustrates EN-DC.

FIG. 6 shows NR-DC.

FIG. 7 is a signaling flow diagram illustrating signaling according to the presently disclosed techniques.

FIG. 8, FIG. 9, and FIG. 10 are process flow diagrams showing example methods as carried out by a UE, an MN, and an SN, respectively.

FIG. 11 shows an example communication system in which the presently disclosed techniques might be employed.

FIG. 12 is a block diagram of an example UE.

FIG. 13 is a block diagram of an example network node.

FIG. 14 illustrates an example host.

FIG. 15 shows a virtualization environment.

FIG. 16 is a communication diagram of a host communicating via a network node with a UE 1606 over a partially wireless connection.

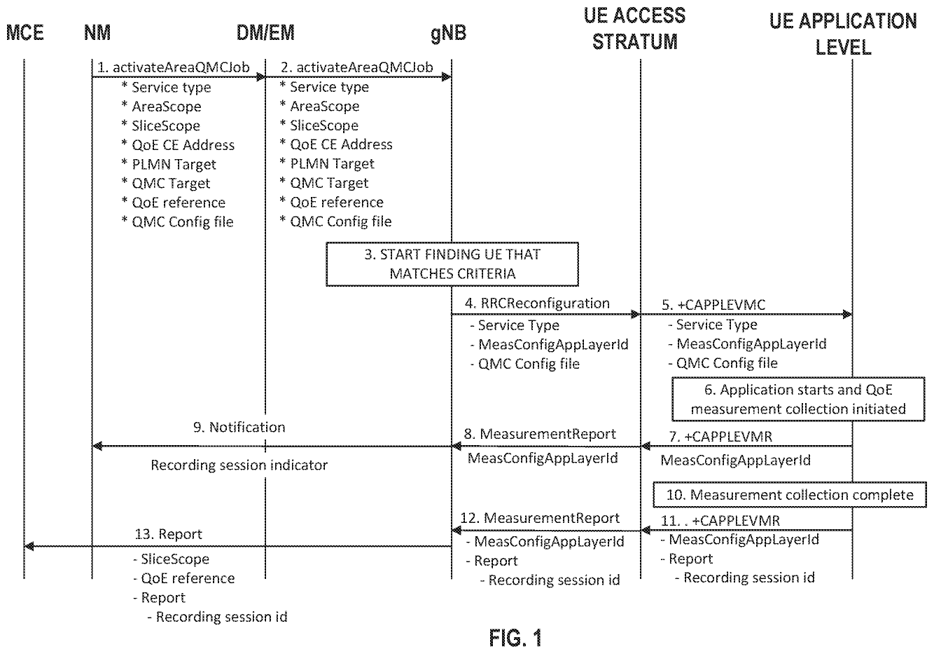

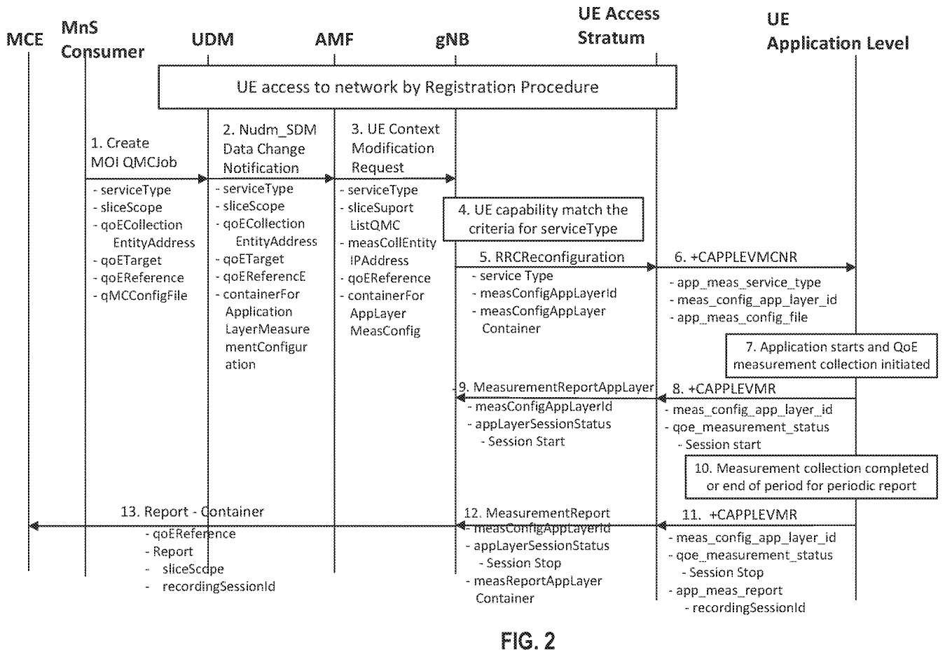

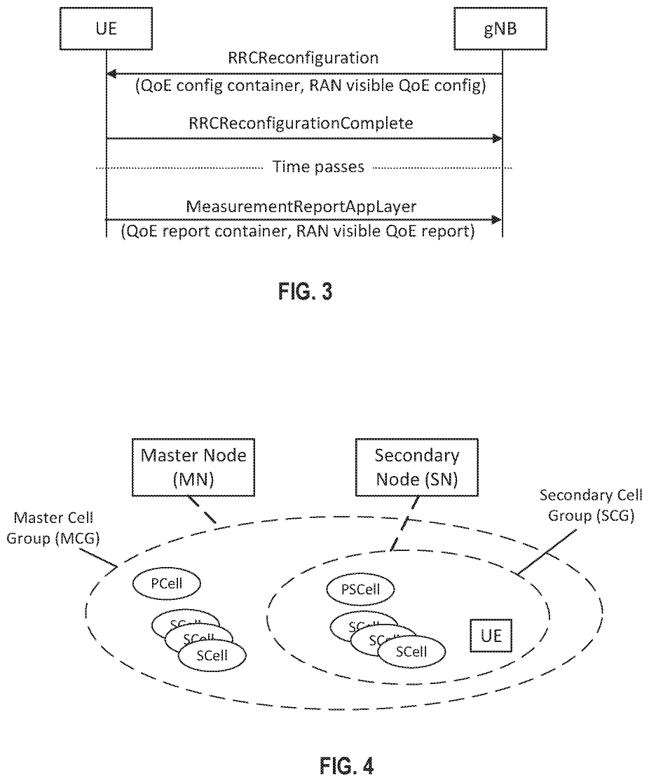

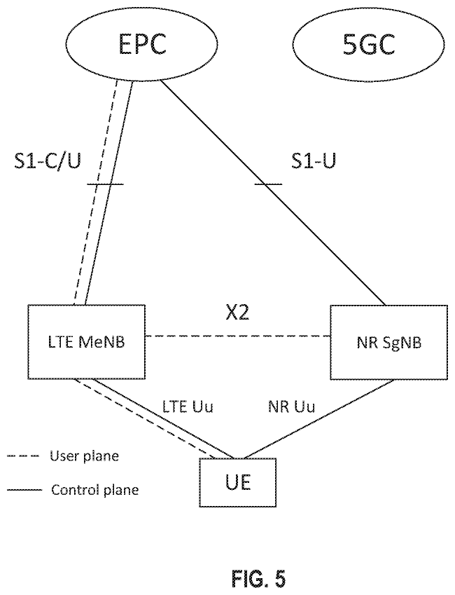

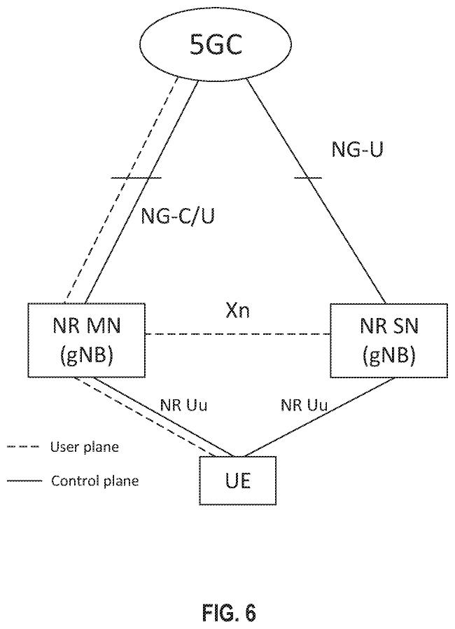

### DETAILED DESCRIPTION

Before describing example embodiments in detail, it is noted that the embodiments reside primarily in combinations of apparatus components and processing steps related to inter-node coordination, e.g., for reporting in multi-node connectivity environments. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections. The term “network node” used herein can be any kind of network node (and/or node) comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a UE (such as a wireless device (WD) or a radio network node).

In some embodiments, the non-limiting terms user equipment (UE) or wireless device (WD) are used interchangeably. The UE herein can be any type of user equipment (e.g., wireless device) capable of communicating with a network node or another UE over radio signals, such as user equipment (UE). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. Although a UE is described, any WD can be implemented. Further, a UE may be considered the same as a WD and not limited to a particular type of wireless device.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In one or more embodiments, one or more of the following may apply:
The solution herein is described on an example of two RAN nodes serving the UE in NR-DC, but it can be generalized to an arbitrary number of nodes simultaneously serving the UE.
The solution herein is described on an example of NR-DC, but it can be generalized to Multi Radio Dual Connectivity (MR-DC) or to connectivity options with more than two RAN nodes as well.
The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected, etc.
All references to the application layer are with respect to the application layer of the UE (since RAN nodes do not have an application layer).
The term “service” is often used as a short notation for “service type”. Therefore, “service” and “service types” may be interchangeably, e.g., unless explicitly stated.
The solution proposed in this invention may apply to both signaling- and management-based QoE measurements (but may also optionally be restricted to apply to only one of them).
The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.
The terms “access stratum” and “radio layer” are used interchangeably when referring to a UE.
The term “session” may refer to either a QoE measurement session or an application session or an application session for which QoE measurement is applied.
The term “session” may refer to either a QoE measurement session or an application session or an application session for which QoE measurement is applied.
The solution proposed in this invention applies to UMTS, LTE and NR as well as future RATs such as 6G.
The solution is described on the example of management based QoE measurements (i.e., their corresponding RVQoE measurements), but it is equally applicable to both management-based and signaling-based QoE measurements, as well as their corresponding RVQoE measurements.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further that functions described herein as being performed by a user equipment or a network node may be distributed over a plurality of user equipment (UEs) and/or network nodes. In other words, it is contemplated that the functions of the network node and user equipment described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In several embodiments in the solution description below, the RAN sends a request to a UE for RVQoE report(s). Such a request may equivalently be referred to as an indication to a UE to send RVQoE report(s) or an indication of fulfillment or a RAN event (or RAN event(s) to trigger RVQoE reporting.

The terms “Handover Command” and “HandoverCommand” are used interchangeably herein. Both terms refer to a UE configuration of a target node (of a regular handover) or a candidate target node (of a conditional handover), during the (conditional) Handover Preparation phase, compiled for the UE to be subject to the handover or conditional handover. This UE configuration is compiled in the form of an RRCReconfiguration message which is conveyed to the UE via the source node. The RRCReconfiguration is associated with a certain target cell or candidate target cell and the UE applies the RRCReconfiguration when/if it accesses the concerned (candidate) target cell controlled by the (candidate) target node. Formally, “HandoverCommand” is an RRC inter-node message which is conveyed from a target node or a candidate target node to a source node during the preparation of a handover or a conditional handover. It is carried by the HANDOVER REQUEST ACKNOWLEDGE XnAP message in the “Target NG-RAN node To Source NG-RAN node Transparent Container” IE. The “HandoverCommand” RRC inter-node message contains an RRCReconfiguration the UE should apply when accessing the target cell or candidate target cell. The source node forwards this RRCReconfiguration (i.e., the HandoverCommand) to the UE. In this solution description, the term “HandoverCommand” is also used to denote this RRCReconfiguration when it is stored in a UE as a part of a CHO configuration. This is also called the condRRCReconfig-r16 IE in the CondReconfigToAddMod-r16 IE (which contains the CHO configuration).

Many field (i.e., parameter) names or IE names in the RRC configuration for NR (3GPP TS 38.331 version 17.1.0) are referred to either as a name with a postfix indicating the 3GPP standard release (e.g., “-r17” indicating 3GPP release 17) or as the same name without the postfix. The version with the postfix is then used in the ASN.1 code, while the version without the postfix is used in other text in the specification. In this document, when applicable (i.e., when both versions of a field's name exist in 3GPP TS 38.331 version 17.1.0), the two versions of the name are used interchangeably. For instance, the names “AppLayerMeasConfig” and “AppLayerMeasConfig-r17” refer to the same IE.

A RAN node can be a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Non-Real Time RAN Intelligent Controller (Non-RT RIC), a Real-Time RAN Intelligent Controller (RT-RIC).

The solution is equally applicable to QoE and RAN-visible QoE measurements and reporting, meaning, among other things that the considerations of QoE configurations, QoE measurements, and QoE reports apply also to RVQoE configurations, RVQoE measurements and RVQoE reports.

Transmission of QoE Reports to the SN when in Dual Connectivity

Note that in all the method descriptions in this disclosure, QoE can be replaced by RVQoE, i.e., the methods are equally applicable to RVQoE as to QoE.

Furthermore, the methods described herein generally include descriptions of how QoE reports destined for a Secondary Node (SN) can be sent, encapsulated in other messages, via the Master Node (MN) associated with the SN. Although not explicitly described in the method descriptions below, this forwarding principle may also be used for sending QoE reports from a UE via a SN to the MN associated with the SN, where the QoE reports are encapsulated in other messages in a similar fashion.

### Use of Transfer Message to Transmit QoE Reports

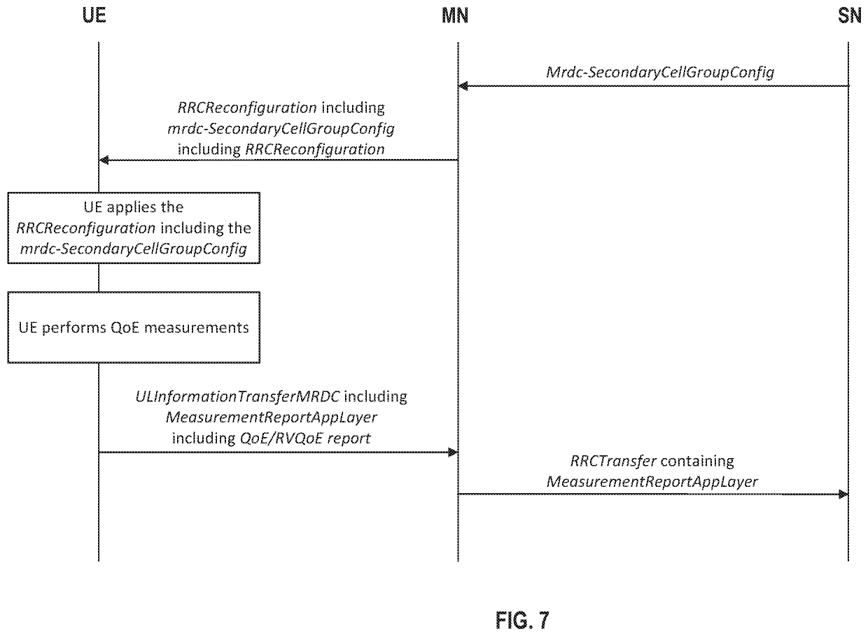

FIG. 7 illustrates the transmission of QoE configuration and QoE reports from/to the SN using transfer messages, in accordance with at least some embodiments of the presently disclosed techniques.

These techniques may be understood as comprising a method in a wireless terminal (also called a User Equipment—UE) configured with dual connectivity, for QoE measurement reporting, the method comprising:
Receiving a message from a Master Node (MN), the message indicating the configuration of QoE measurements where some or all QoE reports are intended for the Secondary Node (SN).
   The message being an RRCReconfiguration message containing the configuration of an SCG related to the Secondary Node (SN) (and, optionally, the configuration of an MCG related to the Master Node (MN)).
   The SCG configuration included in the field nr-SecondaryCellGroupConfig of an OCTET STRING as an RRCReconfiguration;
   The RRCReconfiguration within the OCTET STRING containing a QoE configuration, where the QoE configuration comprises the configuration of QoE measurements to be performed in the SN.
   The message containing an instruction to the UE to include QoE reports generated in accordance with the configuration of QoE measurements in ULInformationTransferMRDC RRC message(s) to be sent to the MN. Specifically, the QoE report(s) should, according to the instruction, be included in MeasurementReportAppLayer RRC message(s), where each such is included in an ULInformationTransferMRDC RRC message.
      The instruction may further include, explicitly or implicitly (by standard specification), that the UE should transmit the ULInformation TransferMRDC RRC message(s) on SRB4.
      Alternatively, the instruction may further include, explicitly or implicitly (by standard specification), that the UE should transmit the ULInformationTransferMRDC RRC message(s) on SRB1.
   Alternatively, the message being a newly defined RRC message.
Applying the SCG configuration containing the configuration of QoE measurements. Forwarding the relevant parts of the QoE configuration to the application layer.
Start performing the measurements in the application layer when the session in the application layer starts. Forwarding the QoE reports from the application layer to the AS layer according to the configuration.
When a QoE report is received in the AS layer:
   Setting the content of an ULInformationTransferMRDC message in accordance with the previously received instruction. The ULInformation TransferMRDC containing a MeasurementReportAppLayer message containing QoE report;
   Submitting the ULInformationTransferMRDC message on SRB4 towards MN.
   Alternatively, submitting the ULInformation TransferMRDC on SRB1 towards MN.
   Alternatively, sending a newly defined message on an existing or newly defined SRB towards the SN
   Alternatively, sending a message containing the QoE report on an SRB3 towards the SN.

The techniques further comprise a method in a Master Node (MN), the method comprising:
(Optionally), receiving from a Secondary Node (SN) a message indicating that the SN has received a management-based QoE configuration, wherein the message optionally may include an identification of the management-based QoE configuration, e.g., a QoE reference.
(Optionally), requesting a Secondary Node (SN) to prepare a configuration of QoE measurements for a UE, where some or all of the QoE reports are to be sent from the UE to the SN.
   The message being an S-NODE MODIFICATION REQUEST or an S-NODE ADDITION REQUEST message or a newly defined XnAP message.
   The decision whether to request the SN to prepare a configuration of QoE measurements for the UE may be based on one or more of:
      Whether the QoE configuration is management-based or signaling-based.
      Whether the MN has received a message from the SN indicating that the SN has received a management-based QoE configuration.
      The service type the QoE configuration targets, e.g., the decision may be different if the service type is MBS than if the service type is MTSI.
      Whether any of the data radio bearers (DRBs) is a split DRB or all DRBs are non-split DRBs, or whether any of the DRBs is a non-split DRB or all DRBs are split DRBs.
      The QFI(s) associated with the SCG DRB(s) and/or the QFI(s) associated with the MCG DRB(s).
      The load experienced in the SN (e.g., traffic load or processing load) and/or in the SCG (e.g., traffic load).
      The load experienced in the SN (e.g., traffic load or processing load) and/or in the SCG (e.g., traffic load).
   The message may include an identification of the QoE configuration, e.g., a QoE reference.
   The message may include an indication of the Service Type the QoE configuration should be associated with.
Receiving a (response (in case the above request was sent to the SN)) message from an SN, the message comprising a message, e.g., a RRCReconfiguration message which may be in the form of an OCTET STRING, and where the RRCReconfiguration message comprises the configuration of QoE measurements, where some or all QoE reports are to be sent from the UE to the SN.
   The message being an S-NODE MODIFICATION REQUEST ACKNOWLEDGE or an S-NODE ADDITION REQUEST ACKNOWLEDGE or an S-NODE MODIFICATION REQUIRED message or an S-NODE CHANGE REQUIRED message or a newly defined XnAP message.
Transmitting a message to the UE, the message indicating the configuration of QoE measurements where some or all QoE reports are intended for the Secondary Node (SN).
   The message being an RRCReconfiguration message containing (optionally, the configuration of an MCG related the Master Node (MN)) and the configuration of an SCG related to the Secondary Node (SN).
   The SCG configuration included in the field nr-SecondaryCellGroupConfig of an OCTET STRING as an RRCReconfiguration;
   The RRCReconfiguration within the OCTET STRING containing a QoE configuration, where the QoE configuration comprises the configuration of QoE measurements to be performed in the UE and which are intended for the SN.
   The message containing an instruction to the UE to include QoE reports generated in accordance with the configuration of QoE measurements in ULInformation TransferMRDC RRC message(s) to be sent to the MN. Specifically, the QoE report(s) should, according to the instruction, be included in MeasurementReportAppLayer RRC message(s), where each such is included in an ULInformation TransferMRDC RRC message.
      The instruction may further include, explicitly or implicitly (by standard specification), that the UE should transmit the ULInformation TransferMRDC RRC message(s) on SRB4.
      Alternatively, the instruction may further include, explicitly or implicitly (by standard specification), that the UE should transmit the ULInformationTransferMRDC RRC message(s) on SRB1.
Receiving an ULInformation TransferMRDC message. The ULInformation TransferMRDC containing a MeasurementReportAppLayer message containing a QoE report generated in accordance with the QoE configuration;
   Receiving the ULInformation TransferMRDC message on SRB4, wherein the ULInformation TransferMRDC message contains a MeasurementReportAppLayer message containing the QoE report.
   Alternatively, receiving the ULInformation TransferMRDC message on SRB1, wherein the ULInformationTransferMRDC message contains a MeasurementReportAppLayer message containing the QoE report.
Transmitting, to the Secondary Node (SN), an RRC TRANSFER message, wherein the RRC TRANSFER message contains the MeasurementReportAppLayer message containing the QoE report.

The techniques further comprise a method in a Secondary Node (SN), the method comprising:
(Optionally), sending to a Maser Node (MN) a message indicating that the SN has received a management-based QoE configuration, wherein the message optionally may include an identification of the management-based QoE configuration, e.g., a QoE reference.
(Optionally), receiving a message from a Master Node (MN) containing a request to prepare a configuration of QoE measurements for a UE, where some or all of the QoE reports are to be sent from the UE to the SN.
   The message being an S-NODE MODIFICATION REQUEST or an S-NODE ADDITION REQUEST message or a newly defined XnAP message.
   The message may include an identification of the QoE configuration, e.g., a QoE reference.
   The message may include an indication of the Service Type the QoE configuration should be associated with.
Preparing the configuration of QoE measurements for a UE, which may be in the form of an RRCReconfiguration message or which may be included in an RRCReconfiguration message (i.e., the preparation may consist of preparing a QoE measurement configuration, eg. In the form of an AppLayerMeasConfig IE, and including the QoE measurement configuration, e.g., the AppLayerMeasConfig IE, in an RRCReconfiguration message.
Transmitting a message to an MN, the message comprising an RRCReconfiguration message that may be in the form of an OCTET STRING, and where the RRCReconfiguration message comprises the configuration of QoE measurements, for which some or all QoE reports are to be sent from the UE to the SN.
   The message being an S-NODE MODIFICATION REQUEST ACKNOWLEDGE or an S-NODE ADDITION REQUEST ACKNOWLEDGE or an S-NODE MODIFICATION REQUIRED message or an S-NODE CHANGE REQUIRED message or a newly defined XnAP message.
Receiving, from a Master Node (MN), an RRC TRANSFER message, wherein the RRC TRANSFER message contains a MeasurementReportAppLayer message containing a QoE report generated by the UE in accordance with the QoE measurement configuration prepared by the SN.

The techniques still further include a method in a Secondary Node (SN) (e.g., the source SN node of an SN Change SN initiated procedure), the method comprising:
Sending an XnAP message requesting a Master Node (MN) to retrieve QoE measurements from a UE, where some or all of the QoE reports are to be sent from the UE to the SN.
   The XnAP message being an S-NODE CHANGE REQUIRED message, an S-NODE MODIFICATION REQUEST ACKNOWLEDGE message, an S-NODE ADDITION REQUEST ACKNOWLEDGE message, an S-NODE MODIFICATION REQUIRED message, an S-NODE CHANGE REQUIRED message or a newly defined XnAP message.
   The QoE reports requested by the SN based on a QoE configuration sent from the MN to the UE according to the methods described above.
   The request being explicit (e.g., including a flag or an ENUMERATED type IE or another type of IE in the XnAP message above) or implicit (e.g., with the sending of the XnAP message above implicitly indicating the request (e.g., in accordance with a standard specification).
(Optionally, e.g., depending on the type of XnAP message the request above was sent in), receiving a response message from the MN, confirming the request sent by the SN.
Receiving a message from the MN, the message comprising a MeasurementReportAppLayer message in the form of an OCTET STRING, and where the MeasurementReportAppLayer message comprises QoE report(s), where the QoE report(s) is (are) to be sent from the UE to the SN.
   The message being an S-NODE CHANGE CONFIRM or an S-NODE CHANGE REFUSE message or a newly defined XnAP message.
   The MeasurementReportAppLayer message being sent from MN to SN and comprising QoE reports for the SN being obtained by the MN from the UE, e.g., as part of SN Change procedure, SN initiated, where the MN, prior to sending a successful confirmation of the SN Change procedure to the SN (with the S-NODE CHANGE CONFIRM XnAP message), or prior to sending an indication to refuse the SN Change to the SN (with the S-NODE CHANGE XnAP message): 1) sends an RRCReconfiguration message optionally including an indication to request the UE to provide the QoE report(s) to be sent to SN, and 2) receives from the UE the QoE report(s) to be forwarded to the SN
   The QoE reports for the SN comprised in the message the SN receives from the SN are obtained based on a QoE configuration sent from the MN to the UE according to the methods described above

The techniques yet further include a method in a Secondary Node (SN) (e.g., the source SN node of an SN Release SN initiated procedure), the method comprising:
Requesting a Master Node (MN) to retrieve QoE measurements from a UE, where some or all of the QoE reports are to be sent from the UE to the SN.
   The message being an S-NODE RELEASE REQUIRED or a newly defined XnAP message.
   The QoE reports requested by the SN based on a QoE configuration sent from the MN to the UE according to the methods described above
   The request being explicit (e.g., including a flag in the XnAP message above) or implicit (e.g., with the sending of the XnAP message above)·
Receiving a (response) message from an MN, the message comprising an MeasurementReportAppLayer message in the form of an OCTET STRING, and where the MeasurementReportAppLayer message comprises QoE reports, where some or all QoE reports are to be sent from the UE to the SN.
   The message being an S-NODE RELEASE CONFIRM or a newly defined XnAP message.
   The MeasurementReportAppLayer message being sent from MN to SN and comprising QoE reports for the SN being obtained by the MN from the UE, e.g., as part of SN Release procedure, SN initiated, where the MN, prior to sending a successful confirmation of the SN Release procedure to the SN (with the S-NODE RELEASE CONFIRM XnAP message) 1) sends an RRCReconfiguration message optionally including an indication to request the UE to provide the QoE report(s) to be sent to SN, and 2) receives from the UE the QoE report(s) to be forwarded to the SN. The QoE reports can be sent to the SN e.g., via the UE CONTEXT RELEASE XnAP message.
   The QoE reports for the SN comprised in the message the SN receives from the SN are obtained based on a QoE configuration sent from the MN to the UE according to the methods described above
      Use of Transfer Message when the UE is Configured with EN-DC or NE-DC

The same methods can be used for UEs being configured with EN-DC or NE-DC. The UE may in the case of EN-DC transmit an LTE ULInformationTransferMRDC message, to an LTE MN, containing an MeasurementReportAppLayer (containing the QoE report) message for transfer to an NR SN in an RRC TRANSFER message. In the case of NE-DC, the UE may transmit, to the MN, an NR ULinformation TransferMRDC message containing an LTE message MeasReportAppLayer (containing the QoE report) for transfer to the SN in an RRC TRANSFER message.

### The Solution in Case of Management-Based QoE Measurements

In general, management based QoE measurements are configured for a group of UEs, where the QoE measurement configuration is the same for all the UEs. In the context of this disclosure, each message exchanged in the communication between the MN and SN described above may, instead of applying to a single UE, apply to two or more UEs for which the SN configures management-based QoE measurements, where all of these UEs have the said SN node as a secondary node and the said MN node as the master node.

In one variant, the message from the SN to the MN asking the MN to retrieve measurements from UEs may comprise the identifiers of multiple UEs from which the measurements are desired. The UEs can be identified, e.g., by their XnAP UE IDs. The corresponding response from the MN may contain a confirmation pertaining to all or some of the said UEs.

In another variant, the message may only contain an indication that the QoE configuration contained in the message from SN to MN refers to management based QoE measurements, without indicating individual UE IDs. In this case, the MN determines the UEs that will be configured with this management based QoE configuration and notifies the SN about which UEs it chose.

With respect to the measurement reporting for management-based QoE for a group of UEs, the UEs can send their reports to the SN via the MN individually. In another variant, the MN collects one or more incoming reports from the UEs and then jointly forwards them to the SN.

The above considerations may apply to all the methods described in sections 6.3.1 and 6.3.2.

### EXAMPLE IMPLEMENTATION

An example implementation in 3GPP TS 38.331 of the solution described above may look like the following (additions in bold, underlined and italic):

An example implementation in 3GPP TS 38.423 of the solution described above may look like this (additions in bold, underlined and italic):

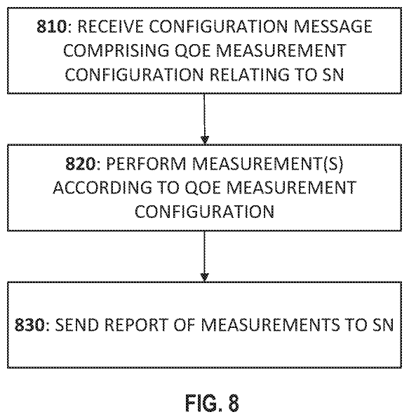

In view of the techniques described above, it will be appreciated that FIG. 8 illustrates an example method in a UE or, more generally, a wireless device operating in an LTE or NR or other wireless network. The illustrated method is intended to be a generalization of at least some of the techniques described above and to encompass those techniques. Thus, where terminology used in the description of the method shown in FIG. 8 differs somewhat from the examples and illustrations provided above, the terminology used below should be understood as interchangeable with or encompassing the similar terminology used above, except where the context makes it clear otherwise.

As shown at block 810, the method comprises receiving, from a radio network node, a configuration message comprising a quality-of-experience (QoE) measurement configuration relating to at least one cell of a secondary node (SN) serving the UE. The method further comprises performing one or more QoE measurements, according to the QoE measurement configuration, as shown at block 820. As shown at block 830, the method still further comprises sending a report of the one or more QoE measurements to a cell of a master node (MN) serving the UE, wherein said sending comprises including the report in a message indicating that the included report is to be transferred to the SN.

In some embodiments, the message sent to the MN is a message type that indicates that the included report is to be transferred to the SN, e.g., a ULInformationTransferMRDC message type as was described in detail above. In some of these embodiments, the configuration message received by the UE includes an indication that measurements relating to the at least one cell of the SN are to be sent in a ULInformation TransferMRDC message. The configuration message may indicate that the UE is to transmit the ULInformationTransferMRDC message(s) on SRB4, or on SRB1, in various embodiments.

Any one or more of the variations discussed above in relation to techniques carried out by or with a UE are applicable to the method shown in FIG. 8.

FIG. 9 illustrates an example method in a network node operating as a master node (MN). Again, the illustrated method is intended to be a generalization of at least some of the techniques described above and to encompass those techniques. Thus, where terminology used in the description of the method shown in FIG. 9 differs somewhat from the examples and illustrations provided above, the terminology used below should be understood as interchangeable with or encompassing the similar terminology used above, except where the context makes it clear otherwise.

The illustrated method comprises, as shown at block 910, sending, to the UE, a configuration message comprising a quality-of-experience (QoE) measurement configuration relating to at least one cell of a secondary node (SN) serving the UE. The method further comprises, as shown at block 920, subsequently receiving, from the UE, a report of one or more QoE measurements relating to the at least one cell of the SN, wherein the report is included in a message indicating that the included report is to be transferred to the SN. As shown at block 930, the method still further comprises sending the report to the SN.

In some embodiments, the message received from the UE is a message type that indicates that the included report is to be transferred to the SN. The message type might be a ULInformation TransferMRDC message type, for instance. In some of these embodiments, the configuration message sent to the UE may include an indication that measurements relating to the at least one cell of the SN are to be sent by the UE to the MN in a ULInformation TransferMRDC message. In some embodiments, the configuration message indicates that the UE is to transmit the ULInformation TransferMRDC message(s) on SRB4, or on SRB1.

In some embodiments, the method comprises receiving the QoE measurement configuration from the SN, prior to sending the QoE measurement configuration to the UE. This is shown in FIG. 9 at block 905.

Any one or more of the variations discussed above in relation to techniques carried out by or with a MN are applicable to the method shown in FIG. 9.

FIG. 10 illustrates an example method in a network node operating as a master node (SN). Once more, the illustrated method is intended to be a generalization of some of the techniques described above and to encompass those techniques. Thus, where terminology used in the description of the method shown in FIG. 10 differs somewhat from the examples and illustrations provided above, the terminology used below should be understood as interchangeable with or encompassing the similar terminology used above, except where the context makes it clear otherwise.

As shown at block 1010, the method illustrated in FIG. 10 comprises sending, to a network node operating as a master node (MN) with respect to the UE, a quality-of-experience (QoE) measurement configuration relating to at least one cell of the SN, for transmission to the UE. As shown at block 1020, the method further comprises receiving, from the MN, a report of one or more QoE measurements made by the UE in accordance with the QoE measurement configuration.

In some embodiments, the method comprises receiving from the MN, prior to sending the QoE measurement configuration, a request to prepare a configuration of QoE measurements, wherein the sending of the QoE measurement configuration is in response to the request. This is shown in block 1005 of FIG. 10.

Any one or more of the variations discussed above in relation to techniques carried out by or with a SN are applicable to the method shown in FIG. 10.

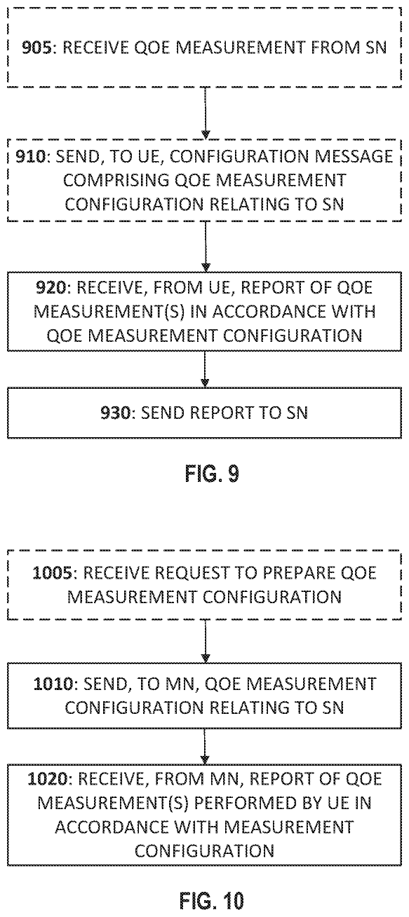

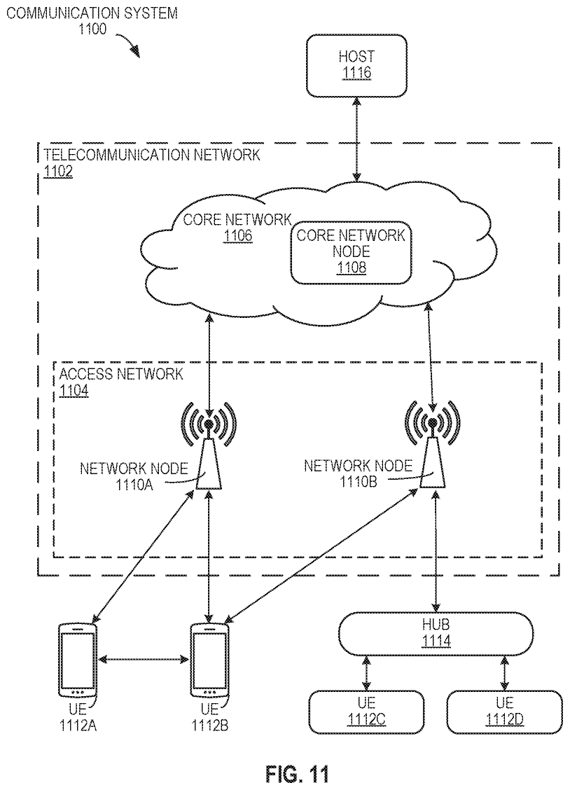

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS): Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

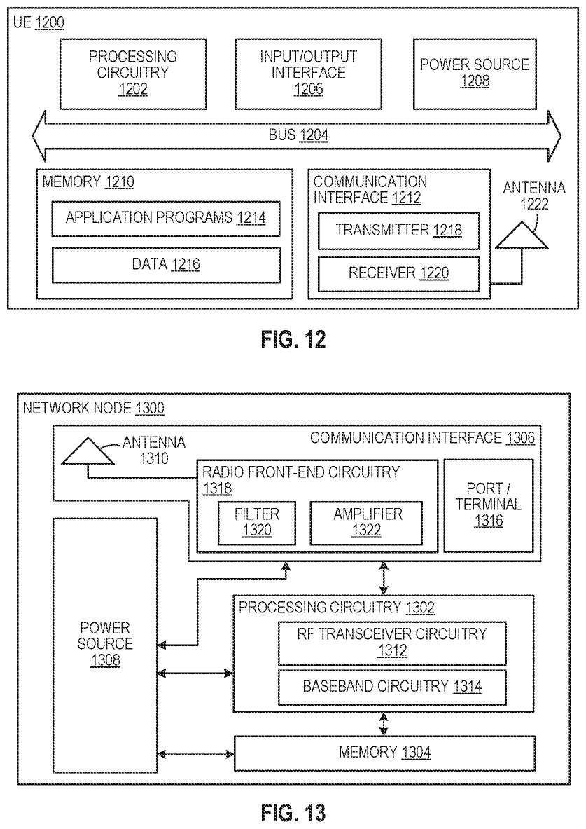

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (IUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network), Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

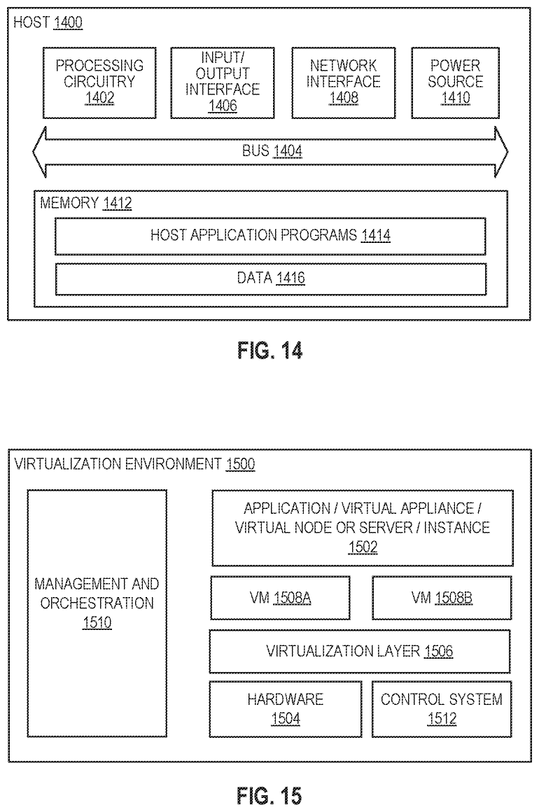

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

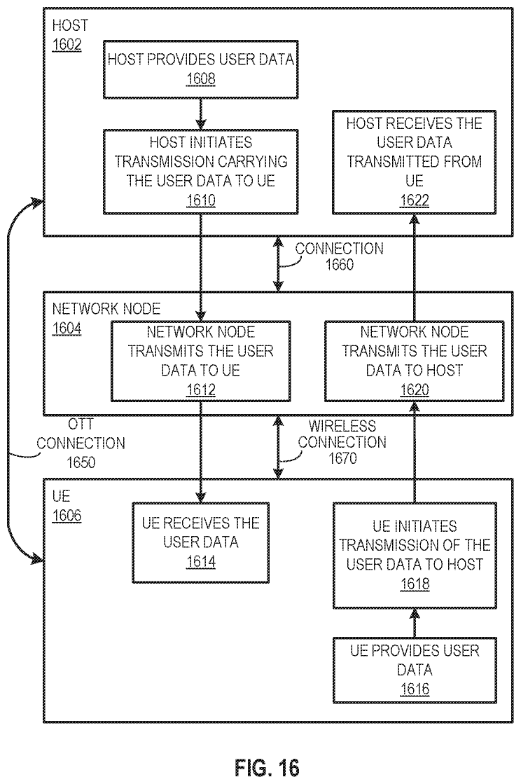

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to Illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may facilitate network management to improve the user experience and thereby provide benefits such as improved throughput, latency, responsiveness, etc.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

Embodiments of the methods, apparatuses, and systems described above include, but are not limited to, the following enumerated examples.

1. A method, in a user equipment (UE), the method comprising:
receiving, from a radio network node, a configuration message comprising a quality-of-experience (QoE) measurement configuration relating to at least one cell of a secondary node (SN) serving the UE;
performing one or more QoE measurements, according to the QoE measurement configuration; and
sending a report of the one or more QoE measurements to a cell of a master node (MN) serving the UE, wherein said sending comprises including the report in a message indicating that the included report is to be transferred to the SN.

2. The method of example embodiment 1, wherein the message sent to the MN is a message type that indicates that the included report is to be transferred to the SN.

3. The method of example embodiment 2, wherein the message type is a ULInformation TransferMRDC message type.

4. The method of example embodiment 3, wherein the configuration message includes an indication that measurements relating to the at least one cell of the SN are to be sent in a ULInformation TransferMRDC message.

5. The method of example embodiment 4, wherein the configuration message indicates that the UE is to transmit the ULInformationTransferMRDC message on SRB4.

6. The method of example embodiment 4, wherein the configuration message indicates that the UE is to transmit the ULInformation TransferMRDC message on SRB1.

7. A method, in a network node operating as a master node (MN) with respect to a user equipment, UE, the method comprising:
sending, to the UE, a configuration message comprising a quality-of-experience (QoE) measurement configuration relating to at least one cell of a secondary node (SN) serving the UE;
subsequently receiving, from the UE, a report of one or more QoE measurements relating to the at least one cell of the SN, wherein said report is included in a message indicating that the included report is to be transferred to the SN; and
sending the report to the SN.

8. The method of example embodiment 7, wherein the message received from the UE is a message type that indicates that the included report is to be transferred to the SN.

9. The method of example embodiment 8, wherein the message type is a ULInformation TransferMRDC message type.

10. The method of example embodiment 9, wherein the configuration message sent to the UE includes an indication that measurements relating to the at least one cell of the SN are to be sent by the UE to the MN in a ULInformation TransferMRDC message.

11. The method of example embodiment 10, wherein the configuration message indicates that the UE is to transmit the ULInformation TransferMRDC message(s) on SRB4.

12. The method of example embodiment 10, wherein the configuration message indicates that the UE is to transmit the ULInformation TransferMRDC message(s) on SRB1.

13. The method of any one of example embodiments 7-12, wherein the method further comprises receiving the QoE measurement configuration from the SN, prior to sending the QoE measurement configuration to the UE.

14. A method, in a network node operating as a secondary node (SN) with respect to a user equipment, UE, the method comprising:
sending, to a network node operating as a master node (MN) with respect to the UE, a quality-of-experience (QoE) measurement configuration relating to at least one cell of the SN, for transmission to the UE; and
receiving, from the MN, a report of one or more QoE measurements made by the UE in accordance with the QoE measurement configuration.

15. The method of example embodiment 14, wherein the method comprises receiving from the MN, prior to sending the QoE measurement configuration, a request to prepare a configuration of QoE measurements, and wherein said sending is in response to the request.

16. A wireless device adapted to carry out a method according to any one of example embodiments 1-6.

17. A wireless device, comprising:
radio circuitry configured to communicate with a wireless network; and
processing circuitry operatively coupled to the radio circuitry and configured to:
   receive, from a radio network node, a configuration message comprising a quality-of-experience (QoE) measurement configuration relating to at least one cell of a secondary node (SN) serving the UE;
   perform one or more QoE measurements, according to the QoE measurement configuration; and
   send a report of the one or more QoE measurements to a cell of a master node (MN) serving the UE, wherein said sending comprises including the report in a message indicating that the included report is to be transferred to the SN.

18. The wireless device of example embodiment 17, wherein the message sent to the MN is a message type that indicates that the included report is to be transferred to the SN.

19. The wireless device of example embodiment 18, wherein the message type is a ULInformation TransferMRDC message type.

20. The wireless device of example embodiment 19, wherein the configuration message includes an indication that measurements relating to the at least one cell of the SN are to be sent in a ULInformation TransferMRDC message.

21. The wireless device of example embodiment 20, wherein the configuration message indicates that the UE is to transmit the ULInformation TransferMRDC message on SRB4.

22. The wireless device of example embodiment 20, wherein the configuration message indicates that the UE is to transmit the ULInformation TransferMRDC message on SRB1.

29. A network node adapted to carry out a method according to any one of example embodiments 7-15.

30. A network node, comprising:
radio circuitry configured to communicate with one or more wireless devices; and processing circuitry operatively coupled to the radio circuitry and configured to use the radio circuitry to:
   send, to a wireless device, configuration information indicating that the wireless device is to log signal quality measurements associated with a mobility event or other radio resource reconfiguration-related event.

31. A network node, comprising:
radio circuitry configured to communicate with one or more wireless devices; and
processing circuitry operatively coupled to the radio circuitry and configured to use the radio circuitry to:
   send, to the UE, a configuration message comprising a quality-of-experience (QoE) measurement configuration relating to at least one cell of a secondary node (SN) serving the UE;
   subsequently receive, from the UE, a report of one or more QoE measurements relating to the at least one cell of the SN, wherein said report is included in a message indicating that the included report is to be transferred to the SN; and
   send the report to the SN.

32. The network node of example embodiment 31, wherein the message received from the UE is a message type that indicates that the included report is to be transferred to the SN.

33. The network node of example embodiment 32, wherein the message type is a ULInformation TransferMRDC message type.

34. The network node of example embodiment 33, wherein the configuration message sent to the UE includes an indication that measurements relating to the at least one cell of the SN are to be sent by the UE to the MN in a ULInformation TransferMRDC message.

35. The network node of example embodiment 34, wherein the configuration message indicates that the UE is to transmit the ULInformation TransferMRDC message(s) on SRB4.

36. The network node of example embodiment 34, wherein the configuration message indicates that the UE is to transmit the ULInformation TransferMRDC message(s) on SRB1.

37. The network node of any one of example embodiments 31-36, wherein the method further comprises receiving the QoE measurement configuration from the SN, prior to sending the QoE measurement configuration to the UE.

38. A network node, comprising:
radio circuitry configured to communicate with one or more wireless devices; and
processing circuitry operatively coupled to the radio circuitry and configured to use the radio circuitry to:
   send, to a network node operating as a master node (MN) with respect to the UE, a quality-of-experience (QoE) measurement configuration relating to at least one cell of the SN, for transmission to the UE; and
   receive, from the MN, a report of one or more QoE measurements made by the UE in accordance with the QoE measurement configuration.

39. The network node of example embodiment 38, wherein the method comprises receiving from the MN, prior to sending the QoE measurement configuration, a request to prepare a configuration of QoE measurements, and wherein said sending is in response to the request.

40. A computer program product comprising computer program instructions for execution on a processor, the computer program instructions being configured to cause the processor to carry out a method according to any of example embodiments 1-15.

41. A computer-readable medium comprising the computer program product of example embodiment 40.

ABBREVIATIONS

| Abbreviation | Explanation |
|---|---|
| 3GPP | 3^{rd} Generation Partnership Project |
| 5GCN | 5G Core Network |
| 5GS | 5G System |
| AF | Application Function |
| AMF | Access and Mobility Management Function |
| AN | Access Network |
| API | Application Programming Interface |
| CA | Carrier Aggregation |
| CGI | Cell Global Identity |
| CHO | Conditional Handover |
| CN | Core Network |
| CP | Control Plane |
| CPC | Conditional PSCell Change |
| CU | Central Unit |
| DAPS | Dual Active Protocol Stacks |
| DC | Dual Connectivity |
| DU | Distributed Unit |
| eNB | E-UTRAN NodeB |
| EN-DC | E-UTRA-NR Dual Connectivity |
| E-UTRA | Evolved UTRA |
| E-UTRAN | Evolved UTRAN |
| gNB | Radio base station in NR |
| GNSS | Global Navigation Satellite System |
| GPS | Global Positioning System |
| ID | Identifier/Identity |
| IE | Information Element |
| LTE | Long Term Evolution |
| MBS | Multicast Broadcast Service |
| MCE | Measurement Collector Entity |
| MME | Mobility Management Entity |
| MN | Master Node |
| MR-DC | Multi-Radio Dual Connectivity |
| NE-DC | NR-E-UTRA Dual Connectivity |
| NEF | Network Exposure Function |
| NG | Next Generation |
| NGEN-DC | NG-RAN E-UTRA-NR Dual Connectivity |
| NG-RAN | NG Radio Access Network |
| NR | New Radio |
| OAM/O&M | Operation and Maintenance |
| PCell | Primary Cell |
| PCF | Policy Control Function |
| PCI | |
| PSCell | Primary Secondary Cell |
| PDU | Protocol Data Unit |
| PLMN | Public Land Mobile Network |
| PTM | Point to Multipoint |
| PTP | Point to Point |
| QCI | QoS Class Identifier |
| QMC | QoE Measurement Collection |
| QoE | Quality of Experience |
| QoS | Quality of Service |
| RACH | Random Access Channel |
| RAN | Radio Access Network |
| RAT | Radio Access Technology |
| RRC | Radio Resource Control |
| RSRP | Reference Signal Received Power |
| RSRQ | Reference Signal Received Quality |
| RSSI | Received Signal Strength Indicator |
| RV-QOE | RAN Visible QoE |
| S1 | The interface between the RAN and the CN in LTE. |
| S1AP | S1 Application Protocol |
| SCell | Secondary Cell |
| SCG | Secondary Cell Group |
| SINR | Signal to Interference and Noise Ratio |
| SMF | Session Management Function |
| SMO | Service Management and Orchestration |
| SN | Secondary Node |
| SNR | Signal to Noise Ratio |
| TA | Terminal Adaptor |
| TCE | Trace Collector Entity |
| TE | Terminal Equipment |
| UE | User Equipment |

1. A method, in a user equipment (UE), the method comprising:
receiving, from a radio network node, a configuration message comprising a quality-of-experience (QoE) measurement configuration relating to at least one cell of a secondary node (SN) serving the UE;
performing one or more QoE measurements, according to the QoE measurement configuration; and
sending a report of the one or more QoE measurements to a cell of a master node (MN) serving the UE, wherein said sending comprises including the report in a message indicating that the included report is to be transferred to the SN.

2. The method of claim 1, wherein the message sent to the MN is a message type that indicates that the included report is to be transferred to the SN.

3. The method of claim 1, wherein the message is a ULInformationTransferMRDC message.

4. The method of claim 1, wherein the configuration message includes an indication that measurements relating to the at least one cell of the SN are to be sent in a ULInformationTransferMRDC message.

5. The method of claim 1, wherein the message is transmitted on SRB4.

6. The method of claim 1, wherein the message is transmitted on SRB1.

7. A method, in a network node operating as a master node (MN) with respect to a user equipment, UE, the method comprising:
sending, to the UE, a configuration message comprising a quality-of-experience (QoE) measurement configuration relating to at least one cell of a secondary node (SN) serving the UE;
subsequently receiving, from the UE, a report of one or more QoE measurements relating to the at least one cell of the SN, wherein said report is included in a message indicating that the included report is to be transferred to the SN; and
sending the report to the SN.

8. The method of claim 7, wherein the message received from the UE is a message type that indicates that the included report is to be transferred to the SN.

9. The method of claim 7, wherein the message is a ULInformationTransferMRDC message.

10. The method of claim 7, wherein the configuration message sent to the UE includes an indication that measurements relating to the at least one cell of the SN are to be sent by the UE to the MN in a ULInformationTransferMRDC message.

11. The method of claim 7, wherein the message is received via SRB4.

12. The method of claim 7, the message is received via SRB1.

13. The method of claim 7, wherein the method further comprises receiving the QoE measurement configuration from the SN, prior to sending the QoE measurement configuration to the UE.

14.-16. (canceled)

17. A wireless device, comprising:
radio circuitry configured to communicate with a wireless network; and
processing circuitry operatively coupled to the radio circuitry and configured to:
receive, from a radio network node, a configuration message comprising a quality-of-experience (QoE) measurement configuration relating to at least one cell of a secondary node (SN) serving the UE;
perform one or more QoE measurements, according to the QoE measurement configuration; and
send a report of the one or more QoE measurements to a cell of a master node (MN) serving the UE, wherein said sending comprises including the report in a message indicating that the included report is to be transferred to the SN.

18. The wireless device of claim 17, wherein the message sent to the MN is a message type that indicates that the included report is to be transferred to the SN.

19. The wireless device of claim 17, wherein the message is a ULInformationTransferMRDC message.

20. The wireless device of claim 17, wherein the configuration message includes an indication that measurements relating to the at least one cell of the SN are to be sent in a ULInformationTransferMRDC message.

21. The wireless device of claim 17, wherein the message is transmitted on SRB4.

22. The wireless device of claim 17, wherein the message is transmitted on SRB1.

23.-24. (canceled)

25. A network node, comprising:
radio circuitry configured to communicate with one or more wireless devices; and
processing circuitry operatively coupled to the radio circuitry and configured to use the radio circuitry to:
send, to the UE, a configuration message comprising a quality-of-experience (QoE) measurement configuration relating to at least one cell of a secondary node (SN) serving the UE;
subsequently receive, from the UE, a report of one or more QoE measurements relating to the at least one cell of the SN, wherein said report is included in a message indicating that the included report is to be transferred to the SN; and
send the report to the SN.

26.-35. (canceled)
